(19) United States
(12) Patent Application Publication
(10) Pub. No.: US 2012/0312806 A1
(43) Pub. Date: Dec. 13, 2012

(54) DEMAND SUPPLY MANAGEMENT OVERRIDE OPTIONS

(75) Inventors: Ashley Wayne Burt, Louisville, KY (US); Michael Francis Finch, Louisville, KY (US); Robert Lafleur, Louisville, KY (US)

(73) Assignee: General Electric Company

(21) Appl. No.: 13/154,952

(22) Filed: Jun. 7, 2011

(51) Int. Cl. H05B 6/68; G05D 23/00; A21B 1/22; F25B 49/00; H05B 1/02; F26B 21/00

(52) U.S. Cl. 219/702; 219/506; 34/524; 219/412; 62/125; 236/94; 62/56; 34/282

(57) ABSTRACT

An appliance and method for enabling a consumer to easily override a low energy mode of an appliance to enable a feature or function of the appliance not typically available in the low energy mode. When an appliance or device is in an energy savings mode, multiple consumer requests for a given feature or function within a prescribed period of time can operate to override the energy savings mode and permit operation of the feature and/or function.

### BACKGROUND OF THE DISCLOSURE

The present disclosure generally relates to energy management, and more particularly to energy management or demand supply management (DSM) of household consumer appliances. The disclosure finds particular application to modifying or incorporating energy saving features and functions into appliances.

Generally, utilities charge a flat rate but as the fuel price increases and there is associated high energy usage select parts of the day, utilities have become more sophisticated with regard to variable rates relating to the energy supplied to customers. As expected, customers or home owners are charged a higher rate during peak demand when energy use is high, and a lower rate when demand for energy is reduced. As will be appreciated, operating a particular home appliance during the different rate periods can result in a substantial difference in energy costs to the home owner.

A basic solution is to have automated responses or operating parameters for particular household appliances in response to the different rates that a utility may charge. For example, during a peak period, rates may be classified as either “critical” or “high” and operation of the appliance may be terminated. On the other hand, where the energy rates are medium or low, operation of the appliance may proceed without alteration. In some instances, certain power consuming functions or features of the appliance may be deactivated or only allowed to operate in a low energy mode.

While automated responses and/or operating parameters for household appliances can achieve more efficient operation for a consumer, the potential exists for consumers to become frustrated when certain features and/or functions of a given appliance are not available. For example, consider a dishwasher wherein the heated drying function is disabled during peak periods. If a consumer needs to operate the dishwasher to wash dishes for an upcoming dinner party, the lack of heated drying can be an annoyance to the consumer especially if the consumer is short on time and cannot hand dry the dishes. Similarly, in the case of a cooking range, if the cooking capacity is reduced in energy savings mode, under some circumstances this could present an inconvenience to the consumer. In some instances, these inconveniences imposed on the consumer may outweigh the additional cost that would be associated with operating the disabled feature of the appliance. If such situations arise frequently, a consumer may be less inclined to utilize power saving features of an appliance.

### SUMMARY OF THE DISCLOSURE

An appliance and method for enabling a consumer to easily override a low energy mode of an appliance to enable a feature or function of the appliance not typically available in the low energy mode. In accordance with one aspect of the disclosure an appliance comprises at least one selectively activatable power consuming feature/function, and a controller operatively connected to the at least one power consuming feature/function, the controller being configured to receive a request to activate the at least one selectively activatable power consuming feature/function and, in response thereto, activate the at least one selectively activatable power consuming feature/function, the controller further being configured to receive and process a signal indicative of utility demand state and in response thereto place the appliance in one of a plurality of operating modes including at least a normal operating mode and an energy savings mode wherein the at least one selectively activatable power consuming feature/function is placed in a low energy mode or disabled. The controller is further configured to return the at least one selectively activatable power consuming feature/function to a normal energy mode when a plurality of requests to activate said at least one selectively activatable power consuming feature/function are received by the controller within a prescribed period of time.

The appliance can include a user input device configured to generate the request to activate the at least one selectively activatable power consuming feature/function. The user input can include at least one button configured to generate a request. The at least one button can be configured to be depressed to generate a request. The plurality of requests can include a first depression of the button followed within the prescribed period of time by a second depression of the button, which can include a long press of the button, for example. The appliance further can include at least one audible or visual indicator, said indicator being configured to notify a user, in response to a first request, that the requested power consuming feature/function is not available when the appliance is in the energy savings mode. In one embodiment, a first request received by the controller activates a timer, and a second request received by the controller while the timer is active causes the controller to return the at least one selectively activatable power consuming feature/function to a normal energy mode. The appliance can include at least one of a range, an oven, a refrigerator, a washer, a dryer, a dishwasher, a microwave oven, a water heater, an air conditioner, or a thermostat, for example.

In accordance with another aspect of the disclosure, a control method for an appliance comprises determining a demand state for an associated energy supplying utility, the demand state being indicative of at least a peak demand period and an off-peak demand period, operating the appliance in a normal mode during the off-peak demand period; operating the appliance in an energy savings mode during the peak demand period; selectively adjusting at least one selectively activatable power consuming feature/function of the appliance to reduce power consumption of the appliance in the energy savings mode; and returning the at least one selectively activatable power consuming feature/function to a normal energy mode when a plurality of requests to activate said at least one selectively activatable power consuming feature/function are received by the controller within a prescribed period of time.

The appliance can include a user input device, the user input device can be configured to generate the request to activate the at least one selectively activatable power consuming feature/function. Upon a first request, a message can be displayed on a display of the appliance indicating that an additional request will return the feature/function to a normal mode. The method can further comprise activating a timer in response to receipt of a first request, and returning the feature/function to a normal state when a second request is received while the timer is active. The timer can be active for at least 3 seconds, for example.

### BRIEF DESCRIPTION OF THE DRAWINGS

FIG. 1 is a block diagram of an exemplary appliance in accordance with the present disclosure.

FIG. 2 is a flowchart illustrating an exemplary method of controlling an appliance in accordance with the present disclosure.

FIG. 3 is a plan view of an exemplary user interface of an appliance in accordance with the disclosure.

### DETAILED DESCRIPTION OF THE PREFERRED EMBODIMENTS

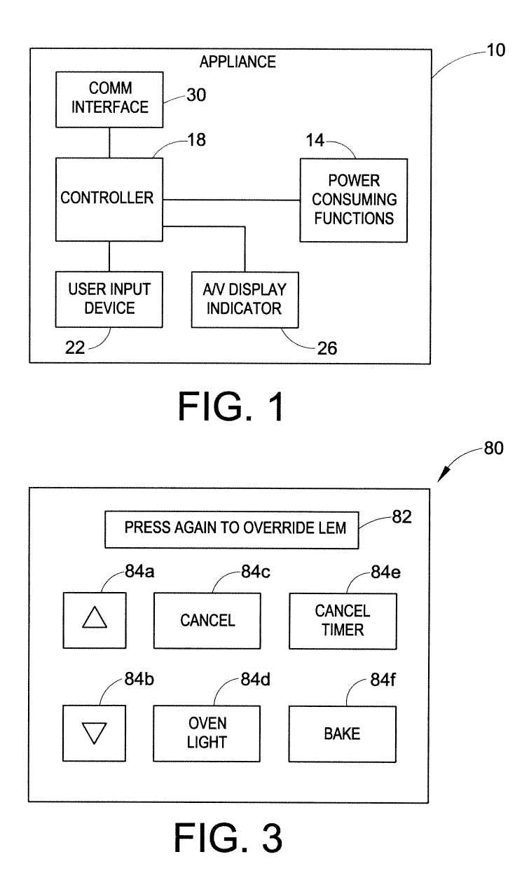

With reference to FIG. 1, an exemplary appliance in accordance with the disclosure is illustrated in a block diagram. The appliance 10 includes one or more power consuming features or functions 14 and a controller 18 configured to control the one or more power consuming functions. As will be appreciated, depending on the appliance, the power consuming functions can include electric motors, heating elements, compressors, pumps, display units, lights, etc. An exemplary appliance may be a cooking range oven which may have one or more heating elements associated with a cooking surface as well as one or more heating elements for heating the oven. A range may also include one or more lights for illuminating the cooking surface and/or the interior of the oven and also a display device for displaying temperature and timers and other information relating to the use and/or operation of the range. Other examples of appliances include water heaters, air conditioners, thermostats, etc.

As is conventional, the controller could be configured to switch the power consuming functions on and off when requested and/or otherwise control the operation of the power consuming functions. In the exemplary embodiment, the appliance also includes a user input device 22, such as a key pad, for allowing a user to select various features of the appliance (such as setting the temperature of the oven, programming a timer, etc.). Associated with the user input device an audio visual display and/or indicator 26 is provided for displaying various information relating to the operation of the appliance and providing feedback to the user in response to data input via the user input device. A communication interface 30 is connected to the controller and is adapted for communicating with a smart meter or a home energy management system etc. An example of a home energy management system is set forth in commonly assigned U.S. patent application Ser. No. 12/559,636 filed on Sep. 15, 2009.

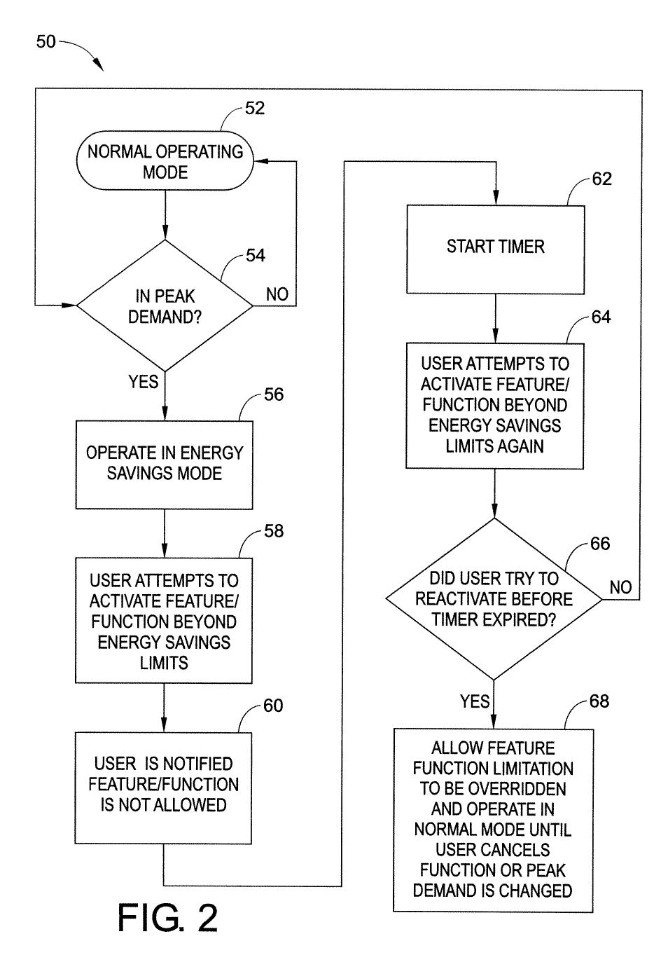

Turning to FIG. 2, an exemplary method of controlling the appliance 10 in accordance with the present disclosure is illustrated in a flowchart 50. The method begins with process step 52 wherein the appliance 10 is operating in a normal mode. The normal operating mode would correspond to a mode wherein most, if not all, of the features of the appliance are available, as opposed to a low energy mode (also referred to as an energy savings mode) wherein fewer than all of the energy consuming features or functions of the appliance are available.

In process step 54, the appliance 10 (or more likely the controller 18) determines or otherwise is informed of a peak demand condition. This can be determined, for example, when a signal sent is receive from the smart meter and/or home energy manager to the appliance 10, the signal corresponding to a peak demand condition. If no peak demand condition is detected, the process reverts to step 52 and the appliance 10 continues to operate in the normal operating mode. If a peak demand condition is detected in process step 54, then the method continues to process step 56 wherein the appliance 10 is entered into an energy savings mode. As noted, in the energy savings mode, one or more of the energy consuming features/functions of the appliance 10 will be unavailable in order to reduce the amount of energy the appliance 10 consumes.

For example, if the appliance is a cooking range in an energy savings mode, the cooking range may operate in a reduced output mode wherein less than all of the electric burners are available for cooking and/or the oven is not available for cooking. Thus, while in the energy savings mode, the cooking range is still available for cooking but in a diminished capacity. Alternatively, it will be appreciated that some appliances, when placed in the energy savings mode, can be essentially rendered inoperative altogether.

In process step 58, if the user attempts to activate an energy consuming feature or function that is not available in the energy savings mode, then the user is notified that the feature of function is not allowed in such mode in process step 60. This notification can be a visual notification, such as a flashing light or text displayed on a display of the device, or can be an audible alert such as a beep or chirp emitted from an appliance. When a user attempts to activate a feature or function that is beyond the energy savings limits of the energy saving mode, a timer is started in process step 62. If a user attempts to activate the feature or function that is not available in the energy savings mode a second time while the timer is active, then the feature or function limitation is overridden and the appliance 10 is allowed to operate said feature/function/appliance in normal mode until the user cancels the function or a peak demand condition is changed. These features are set forth in process steps 62, 64, 66, and 68.

As can be seen, once the timer is started in process step 62, when a user then attempts to activate the feature of function beyond the energy savings limits again in process 64, the appliance 10 will determine whether the user tried to reactivate the feature or function before the timer expired in process step 66. If the timer expired before the user attempted to reactivate the feature or function, then the method returns to process step 54. If, however, the user tried to reactivate the feature or function before the timer expired (e.g., while the timer was active), then the method continues to process step 68 and the appliance allows the feature or function limitation to be overridden and operate in normal mode until the user cancels the function or the peak demand condition is changed.

It will be appreciated that the appliance 10 can be configured to either allow the feature or function requested by the user to be operated as it would be in normal mode while still maintaining the remaining features and functions of the appliance in an energy savings mode, or the appliance 10 can be configured to return to a normal operating mode wherein all of the energy consuming features and functions are available. In other words, after a user requests a certain feature not available in the energy savings mode, two times within a prescribed period of time, the appliance 10 can be configured to return to its normal operating mode. From an energy savings perspective, however, it will usually be desirable simply to enable the requested feature while retaining the other features and functions of the appliance in the energy savings mode.

Turning now to FIG. 3, an exemplary user interface for a cooking range is shown and generally identified by reference numeral 80. The user interface includes a display 82 and a plurality of buttons 84a-84f that are used to operate certain features and functions of a cooking range. For example, buttons 84a and 84b are directional buttons that may be used to cycle through various menus and/or to set a temperature or increase or decrease the time of a timer. Button 84c is a cancel button, button 84d operates the oven light, button 84e activates a cook timer, and button 84f is provided for turning on the range oven.

In accordance with the present disclosure, the display 82 is displaying a notice to the user in response to the user attempting to activate a feature or function of the range oven that is not available in the energy savings mode. By way of example, this could be attempting to turn on the oven by pressing the bake button 84f. In accordance with the present disclosure, the appliance is configured to display the message “press again to override LEM” indicating to the user that the feature is not available in the energy savings mode but that it can be made available by again requesting the feature or function. Thus, if a user then again attempts to activate the oven by pressing bake button 84f, the appliance 10 is configured to allow the range oven to be operated even though the appliance may remain in an energy savings mode wherein the range oven would otherwise be unavailable.

As will now be understood, the present disclosure provides an appliance and method that enables a consumer to easily override the low energy mode to enable a feature or function of the appliance that is not typically available in the low energy mode. By simplifying the override of the low energy mode for a given feature. The present disclosure may encourage use of low energy modes among consumers since consumers will come to understand that they can easily avail themselves of the full features and functions of an appliance even though that appliance is set in an energy savings mode. This can also reduce consumer dissatisfaction that would otherwise arise from features being unavailable during low energy savings mode and reduces the hassle to the consumer of needing to figure out how to remove an appliance from an energy savings mode.

The invention has been described with reference to the preferred embodiments. Obviously, modifications and alterations will occur to others upon reading and understanding the preceding detailed description. It is intended that the invention be construed as including all such modifications and alterations.

What is claimed is:

1. An appliance comprising:
at least one selectively activatable power consuming feature/function; and
a controller operatively connected to the at least one power consuming feature/function, the controller being configured to receive a request to activate the at least one selectively activatable power consuming feature/function and, in response thereto, activate the at least one selectively activatable power consuming feature/function, the controller further being configured to receive and process a signal indicative of utility demand state and in response thereto place the appliance in one of a plurality of operating modes including at least a normal operating mode and an energy savings mode wherein the at least one selectively activatable power consuming feature/function is placed in a low energy mode or disabled;
wherein the controller is further configured to return the at least one selectively activatable power consuming feature/function to a normal energy mode when a plurality of requests to activate said at least one selectively activatable power consuming feature/function are received by the controller within a prescribed period of time.

2. An appliance as set forth in claim 1, wherein the appliance includes a user input device, the user input device configured to generate the request to activate the at least one selectively activatable power consuming feature/function.

3. An appliance as set forth in claim 2, wherein the user input includes at least one button configured to generate a request.

4. An appliance as set forth in claim 3, wherein the at least one button is configured to be depressed to generate a request.

5. An appliance as set forth in claim 4, wherein the plurality of requests include a first depression of the button followed within the prescribed period of time by a second depression of the button.

6. An appliance as set forth in claim 5, wherein the second depression includes a long press of the button.

7. An appliance as set forth in claim 2, wherein the appliance further includes at least one audible or visual indicator, said indicator is configured to notify a user, in response to a first request, that the requested power consuming feature/function is not available when the appliance is in the energy savings mode.

8. An appliance as set forth in claim 1, wherein a first request received by the controller activates a timer, and wherein a second request received by the controller while the timer is active causes the controller to return the at least one selectively activatable power consuming feature/function to a normal energy mode.

9. An appliance as set forth in claim 1, wherein the appliance includes at least one of a range, an oven, a refrigerator, a washer, a dryer, a dishwasher, a microwave oven, a water heater, an air conditioner, or a thermostat.

10. A control method for an appliance comprising:
determining a demand state for an associated energy supplying utility, the demand state being indicative of at least a peak demand period and an off-peak demand period;
operating the appliance in a normal mode during the off-peak demand period;
operating the appliance in an energy savings mode during the peak demand period;
selectively adjusting at least one selectively activatable power consuming feature/function of the air conditioner to reduce power consumption of the air conditioner in the energy savings mode based; and
returning the at least one selectively activatable power consuming feature/function to a normal energy mode when a plurality of requests to activate said at least one selectively activatable power consuming feature/function are received by the controller within a prescribed period of time.

11. A control method for an appliance as set forth in claim 1, wherein the appliance includes a user input device, the user input device configured to generate the request to activate the at least one selectively activatable power consuming feature/function.

12. A control method for an appliance as set forth in claim 10, wherein upon a first request, a message is displayed on a display of the appliance indicating that an additional request will return the feature/function to a normal mode.

13. A control method as set forth in claim 10, further comprising activating a timer in response to receipt of a first request.

14. A control method as net forth in claim 13, further comprising returning the feature/function to a normal state when a second request is received while the timer is active.

15. A control method as set forth in claim 14, wherein the timer is active for at least 3 seconds.
